(19) United States
(12) Patent Application Publication
(10) Pub. No.: US 2016/0367039 A1
(43) Pub. Date: Dec. 22, 2016

(54) Device and Method of Automated Substrate Control and Non-Intrusive Subject Monitoring

(71) Applicant: SleepIQ Labs Inc., San Jose, CA (US)

(72) Inventors: Steven J. Young, Los Gatos, CA (US); Carl Hewitt, San Jose, CA (US); Al Luckow, Ben Lomond, CA (US)

(73) Assignee: SleepIQ Labs Inc., San Jose, CA (US)

(21) Appl. No.: 14/740,832

(22) Filed: Jun. 16, 2015

(51) Int. Cl. A47C 27/08; F04D 27/00; G05B 15/02

(52) U.S. Cl. CPC A47C 27/083; G05B 15/02; F04D 27/00

(57) ABSTRACT

This application describes methods and devices for controlling the firmness of a substrate. In response to detecting the presence of a subject on the substrate, one method includes setting the firmness of the substrate to a base firmness equalized with atmospheric pressure. In response to receiving a request to modify the firmness of the substrate from the base firmness to a requested firmness, the method further includes setting the firmness of the substrate to the requested firmness. In response to detecting the absence of the subject, the method further includes restoring the firmness of the substrate from the requested firmness to the base firmness.

### FIELD OF THE INVENTION

The present disclosure pertains in general to automated substrate control and non-intrusive monitoring of the presence, condition, and firmness preferences of a subject on a substrate such as a mattress.

### BACKGROUND

Current forms of automated firmness control rely on substrates including fluid-only bladders where the pressure in such bladders is modified using internal or external pumps. Use of a pump to control firmness in a substrate requires an integrated control system that greatly increases the expense of a variable firmness substrate. Thus, a pump-less system that still provides variable firmness is desired.

### SUMMARY

Methods and devices for automatically controlling a substrate in response to a monitored subject are disclosed.

One such method includes detecting presence of a subject on the substrate; in response to detection of the presence of the subject, setting the firmness of the substrate to a base firmness equalized with atmospheric pressure; in response to receiving a request to modify the firmness of the substrate from the base firmness to a requested firmness, setting the firmness of the substrate to the requested firmness; detecting absence of the subject on the substrate; and in response to detection of the absence of the subject, restoring the firmness of the substrate from the requested firmness to the base firmness.

Another method includes detecting presence of a subject on the substrate; in response to detection of the presence of the subject, setting the firmness of the substrate to a base firmness equalized with atmospheric pressure; detecting identity of the subject on the substrate; in response to detection of the identity of the subject, setting the firmness of the substrate to an identity-specific firmness; detecting absence of the subject on the substrate; and in response to detection of the absence of the subject, restoring the firmness of the substrate from the specified firmness to the base firmness.

A automatically-controlled substrate includes a fluid bladder; a foam core disposed within the fluid bladder; one or more sensors in fluid communication with the fluid bladder; a valve having an open position allowing fluid communication between atmosphere and an interior of the fluid bladder and the foam core and a closed position blocking fluid communication between atmosphere and the interior of the fluid bladder and the foam core; and a processor. The processor is configured to detect, based on signals from the one or more sensors, presence of a subject on the substrate; in response to detection of the presence of the subject, set firmness of the substrate to a base firmness equalized with atmospheric pressure; in response to receiving a request to modify the firmness of the substrate from the base firmness to a requested firmness, set the firmness of the substrate to the requested firmness; detect absence of the subject on the substrate; and in response to detection of the absence of the subject, restore the firmness of the substrate from the requested firmness to the base firmness.

### BRIEF DESCRIPTION OF THE DRAWINGS

The description makes reference to the accompanying drawings, wherein like reference numerals refer to like parts throughout the several views, and wherein:

FIG. 1 is a diagram of a computing and communications system in accordance with implementations of this disclosure;

FIG. 2 is a diagram of an example computing and communication device in accordance with implementations of this disclosure;

FIG. 3 is a schematic of a substrate in a collapsed condition in accordance with implementations of this disclosure;

FIG. 4 is a schematic of the substrate of FIG. 3 in transition from the collapsed condition to an expanded condition in accordance with implementations of this disclosure;

FIG. 5 is a side view of the substrate of FIG. 4 in the expanded condition in the process of achieving a base firmness equalized with atmospheric pressure in accordance with implementations of this disclosure;

FIG. 6 is a side view of the substrate of FIG. 5 in a use condition in the process of achieving a requested firmness in accordance with implementations of this disclosure;

FIG. 7 is a representative system architecture for monitoring the presence of a subject in accordance with implementations of this disclosure; and

FIG. 8 is a flowchart detailing an example process of automatic firmness control in accordance with implementations of this disclosure.

### DETAILED DESCRIPTION

A substrate, such as a mattress, and methods for controlling the firmness of the substrate are described below. The substrate can include a compressible foam core disposed within a fluid bladder and a pressure-controlled valve allowing fluid communication between the environment and the interior of the fluid bladder and the foam core. In one embodiment, and in the absence of a subject on the substrate, the pressure-controlled valve can remain open, allowing the foam core to expand to its full extent and the pressure within the fluid bladder to equalize with atmospheric pressure for a base firmness. In another embodiment, a check valve may be employed in combination with the pressure-controlled valve, the check valve opening automatically in the absence of pressure on the substrate and allowing the substrate to fill to ambient pressure. Once a subject is detected on the substrate, the pressure-controlled valve (or both valves) can close, setting the base firmness, until a request is received to modify the firmness of the substrate.

This request to modify the firmness of the substrate can be generated by the subject through use of an application on a remote device or be automatically generated in response to the subject being identified on the substrate. To modify the firmness to either a requested firmness or an identity-specific firmness, the pressure-controlled valve can be opened only for a time period sufficient to soften the substrate to the requested firmness or the identity-specific firmness. After the subject is detected as absent from the substrate, the pressure-controlled valve, or if present, the check valve, can reopen to restore the base firmness. These methods are implemented without the need for a pump as part of the substrate.

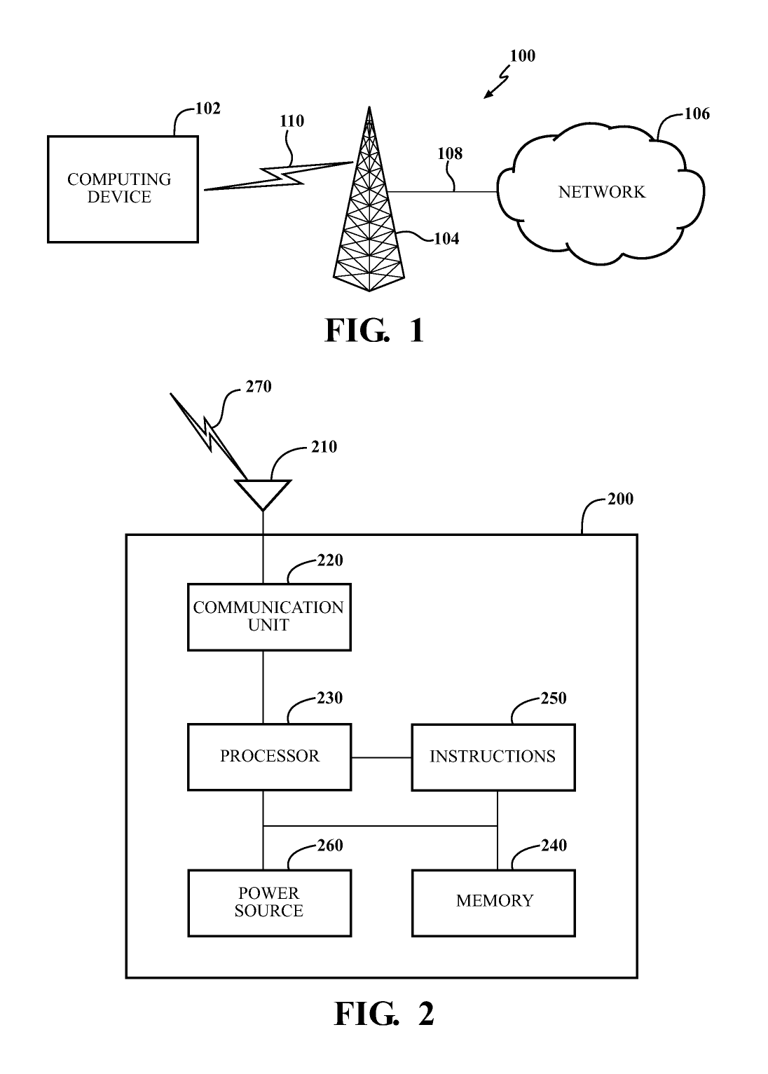

FIG. 1 is a diagram of a computing and communications system 100 in accordance with implementations of this disclosure. The computing and communications system 100 can include one or more computing devices 102, one or more access points 104, and one or more networks 106. Although shown here as including a single computing device 102, access point 104, and network 106, the computing and communications system 100 can include any number of computing and communication devices, access points, and networks.

The computing device 102 can be any device or system configured to perform wired or wireless communication. For example, the computing device 102 can communicate indirectly with the network 106 via the access point 104 using a combination of a wired communication link 108 and wireless communication link 110. Although the computing device 102 is shown as a single unit, the computing device 102 can include any number of interconnected elements.

The access point 104 can be any type of device configured to communicate with the computing device 102, the network 106, or both, via wired or wireless communication links 108/110. For example, the access point 104 can include a base station, a base transceiver station (BTS), a Node-B, an enhanced Node-B (eNode-B), a Home Node-B (HNode-B), a wireless router, a wired router, a hub, a relay, a switch, or any similar wired or wireless device. The access point 104 can communicate with the network 106 via a wired communication link 108 as shown, or via a wireless communication link, or a combination of wired and wireless communication links. Although the access point 104 is shown as a single unit, the access point 104 can include any number of interconnected elements.

The network 106 can be any type of network configured to provide services, such as voice, data, or any other communications protocol or combination of communications protocols, over a wired or wireless communication link. For example, the network 106 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the Hyper Text Transport Protocol (HTTP), or a combination thereof.

FIG. 2 is a diagram of an exemplary computing and communication device 200 in accordance with implementations of this disclosure. For example, the computing device 102 shown in FIG. 1 can be a computing and communication device 200 as shown in FIG. 2. A computing and communication device 200 can include a communication interface 210, a communication unit 220, a processor 230, a memory 240, instructions 250, a power source 260, or any combination thereof. As used herein, the term “computing device” includes any unit, or combination of units, capable of performing any method, or any portion or portions thereof, disclosed herein.

The computing and communication device 200 can be a stationary computing device or a mobile computing device. For example, the computing and communication device 200 can be a personal computer (PC), a server, a workstation, a minicomputer, a mainframe computer, a mobile telephone, a personal digital assistant (PDA), a laptop, a tablet PC, or an integrated circuit. Although shown as a single unit, any one or more elements of the communication device 200 can be integrated into any number of separate physical units.

The communication interface 210 can be a wireless antenna, as shown, a wired communication port, such as an Ethernet port, an infrared port, a serial port, or any other wired or wireless unit capable of interfacing with a wired or wireless communication medium 270. The communication unit 220 can be configured to transmit or receive signals via a wired or wireless communication medium 270, such as radio frequency (RF), ultra violet (UV), visible light, fiber optic, wire line, or a combination thereof. Although FIG. 2 shows a single communication unit 220 and a single communication interface 210, any number of communication units and any number of communication interfaces can be used.

The processor 230 can include any device or system capable of manipulating or processing a signal or other information, such as optical processors, quantum processors, molecular processors, or a combination thereof. For example, the processor 230 can include a general purpose processor, a special purpose processor, a conventional processor, a digital signal processor (DSP), a plurality of microprocessors, one or more microprocessor in association with a DSP core, a controller, a micro controller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors. The processor can be operatively coupled with the communication unit 220, the memory 240, the instructions 250, the power source 260, or any combination thereof.

The memory 240 can include any non-transitory computer-usable or computer-readable medium, such as any tangible device that can, for example, contain, store, communicate, or transport the instructions 250, or any information associated therewith, for use by or in connection with the processor 230. The non-transitory computer-usable or computer-readable medium can be, for example, a solid state drive, a memory card, removable media, a read only memory (ROM), a random access memory (RAM), any type of disk including a hard disk, a floppy disk, an optical disk, a magnetic or optical card, an application specific integrated circuits (ASICs), or any type of non-transitory media suitable for storing electronic information, or any combination thereof. The memory 240 can be connected to, for example, the processor 230 through, for example, a memory bus (not explicitly shown).

The instructions 250 can include directions for performing any method, or any portion or portions thereof, disclosed here. The instructions 250 can be implemented in hardware, software, or any combination thereof. For example, the instructions 250 can be implemented as information stored in the memory 240, such as a computer program, that can be executed by the processor 230 to perform any of the respective methods, algorithms, aspects, or combinations thereof, as described here. The instructions 250, or a portion thereof, can be implemented as a special purpose processor, or circuitry, that can include specialized hardware for carrying out any of the methods, algorithms, aspects, or combinations thereof, as described herein. Portions of the instructions 250 can be distributed across multiple processors on the same machine or different machines or across a network such as a local area network, a wide area network, the Internet, or a combination thereof.

The power source 260 can be any suitable device for powering the computing and communication device 200. For example, the power source 260 can include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the communication device 200. The communication interface 210, the communication unit 220, the processor 230, the instructions 250, the memory 240, or any combination thereof, can be operatively coupled with the power source 260.

Although not shown in FIG. 2, in some embodiments, the computing and communication device 200 can include a user interface (UI), which can be any unit capable of interfacing with a user, such as a virtual or physical keypad, a touchpad, a display, a touch display, a speaker, a microphone, a video camera, a sensor, or any combination thereof. The UI can be operatively coupled with the processor, as shown, or with any other element of the computing and communication device 200, such as the power source 260. Although shown as a single unit, the UI can include one or more physical units. For example, the UI can include an audio interface for performing audio communication with a user, and a touch display for performing visual and touch based communication with the user.

FIG. 2 shows one exemplary configuration of a computing and communication device 200 and is not meant to imply limitations with respect to the embodiments. Other elements can be used in addition to or in the place of the depicted elements, and the computing and communication device 200 can be implemented on a variety of hardware platforms and software environments, such as various operating systems. Although shown as separate elements, the communication interface 210, the communication unit 220, the processor 230, the instructions 250, the power source 260, the memory 240, the UI, or any combination thereof can be integrated in one or more electronic units, circuits, or chips.

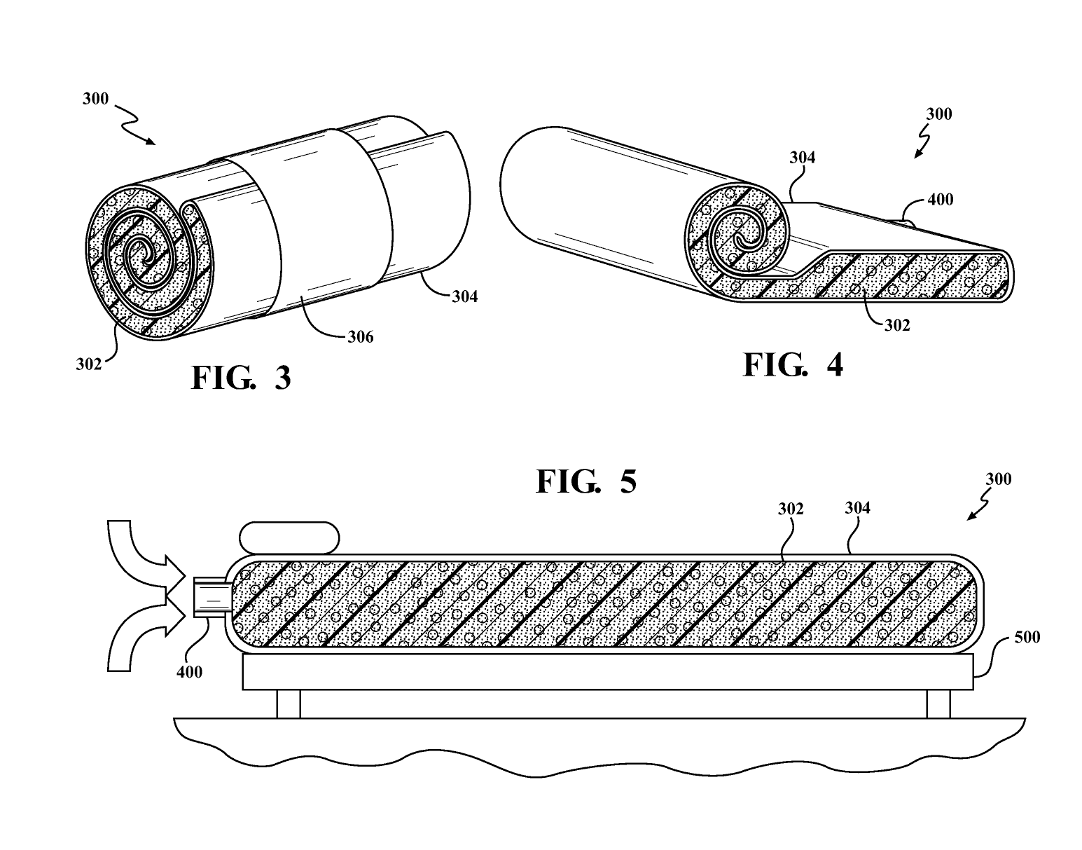

FIG. 3 is a schematic of a substrate 300 in a collapsed condition in accordance with implementations of this disclosure. The substrate 300 can include a foam core 302 disposed within a fluid bladder 304. The foam core 302 is shown as compressed in the collapsed condition to allow for easy storage and transportation of the substrate 300 based on the compact size. In the example of FIG. 3, a band 306 is wrapped around the compressed substrate 300 to facilitate keeping the substrate 300 in the collapsed condition, though other means of holding the substrate 300 in the collapsed condition are also possible.

FIG. 4 is a schematic of the substrate 300 of FIG. 3 in transition from the collapsed condition to an expanded condition. In FIG. 4, the band 306 has been removed from the substrate 300, for example, by a user, and the foam core 302 within the substrate 300 is in process of expanding as the substrate 300 unrolls. Additionally, a valve 400 is shown disposed at one edge of the substrate 300. The valve 400 has an open position allowing fluid communication between atmosphere and an interior of the fluid bladder 304 and the foam core 302 and a closed position blocking fluid communication between atmosphere and the interior of the fluid bladder 304 and the foam core 302. In other words, when the valve 400 is open, air can enter and exit the fluid bladder 304 to facilitate expansion and compression of the foam core 302.

FIG. 5 is a side view of the substrate 300 of FIG. 4 in the expanded condition during the process of automatically achieving a base firmness equalized with atmospheric pressure. In this example, the substrate 300 has been installed on a frame, or a foundation 500, for use as a mattress. To achieve base firmness in the absence of any subjects or objects on the substrate 300, the valve 400 is set to the open position, allowing fluid communication between the atmosphere and the interior of the fluid bladder 304 and the foam core 302. The fluid bladder 304 can be sized to have a surface area substantially as large as the surface area of the foundation 500. For example, the fluid bladder 304 can have a surface area substantially as large as a king-size, queen-size, full, twin, or other sized mattress.

In the example of FIG. 5 where the fluid is air, arrows are shown indicating the direction of flow into the open valve 400 with the air expanding the foam core 302 within the fluid bladder 304 to a point of equilibrium, that is, to a point where the pressure inside the fluid bladder 304 becomes equal to atmospheric pressure. Achieving base firmness can include allowing fluid to enter the valve 400 when atmospheric pressure is above that present within the fluid bladder 304 or allowing fluid to exit the valve 400 when atmospheric pressure is below that present within the fluid bladder. Additionally, fixing the base firmness of the fluid bladder 304 can include closing the valve 400 once the pressure inside and outside of the fluid bladder 304 has equalized.

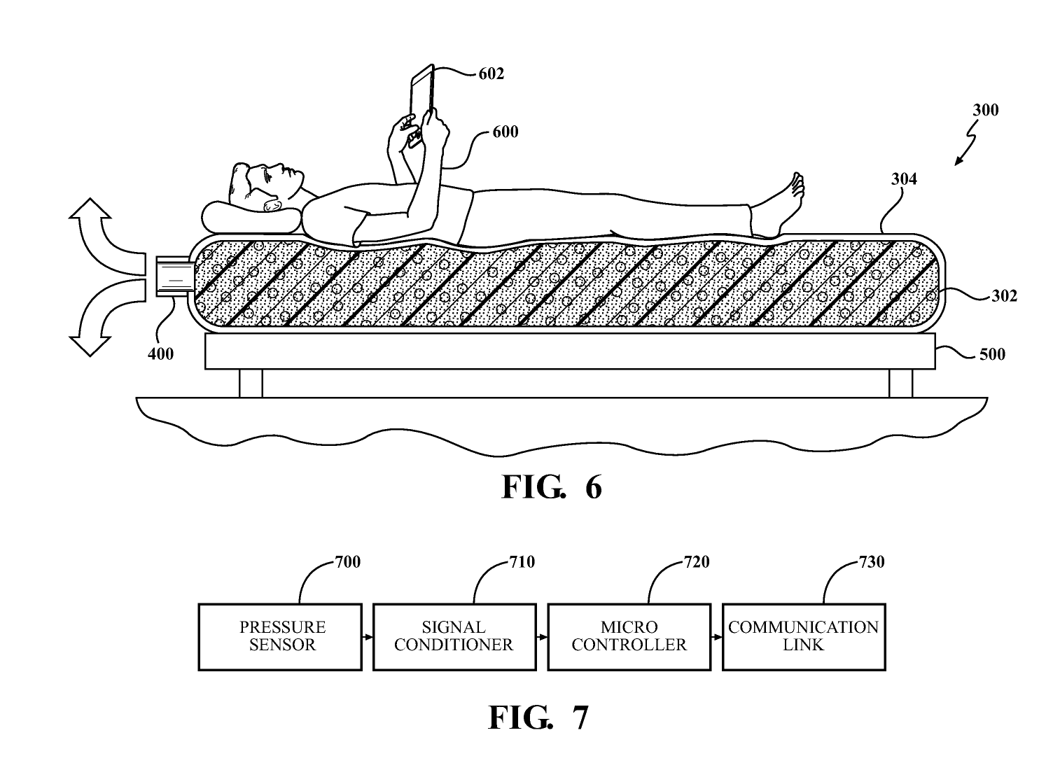

FIG. 6 is a side view of the substrate 300 of FIG. 5 in a use condition during the process of achieving a requested firmness. In this example, the use condition is indicated based on a subject 600 lying on top of the substrate 300. The presence of the subject 600 can be detected on the substrate 300, for example, by a non-intrusive monitoring apparatus. In some embodiments, the non-intrusive monitoring apparatus can include one or more pressure sensors within the fluid bladder 304 and in communication with the valve 400.

The non-intrusive monitoring apparatus can be configured to detect an action or condition of the subject 600, such as presence, movement, position, or vital signs. Incident pressure waves caused by shifting body weight in response to cardiopulmonary activity can induce a change in pressure that can be detected and measured by the pressure sensors. Vital signs capable of being monitored can include a heart rate, a respiration rate, a position of, and any movement of the subject 600.

Once the presence of the subject 600 is detected, the firmness of the substrate 300 can be set to the base firmness equalized with atmospheric pressure, by, for example, closing the valve 400 immediately after presence of the subject 600 is detected. After the base firmness is fixed, the process of achieving the requested firmness can include opening the valve 400 to allow fluid to either enter or exit the fluid bladder 304 based on a pressure value associated with the requested firmness.

Though a single valve 400 is shown in FIGS. 4-6, the substrate 300 can be configured to include a pair of valves, one being a pressure-controlled valve and one being a single-direction check valve. As the subject 600 puts pressure on the substrate 300, for example, by entering a bed by lying on a mattress, the check valve can close and the pressure-controlled valve can be then engaged to achieve the requested firmness by any of the methods described below. When the subject 600 leaves the substrate 600, the check valve can open automatically to restore the substrate 300 to base firmness equalized with ambient pressure.

Several different methods of implementing the requested firmness for the substrate 300 are possible. In one method, the non-intrusive monitoring apparatus can receive a request from an external device 602, such as a remote device or a mobile device, via a wired or wireless communication link to implement the requested firmness. In this example, the non-intrusive monitoring apparatus can include a monitoring controller in the form of a computing and communication device, such as the computing and communication device 102 shown in FIG. 1 or the computing and communication device 200 shown in FIG. 2, that can be configured to communicate with the external device 602 via a wired or wireless communication link. For example, the monitoring controller can receive a signal indicating a desired pressure for the fluid bladder 304 and can control the valve 400 to open or close to change the pressure in the fluid bladder 304 to match the desired pressure and achieve the requested firmness.

In another method, the external device 602 can serve as the monitoring controller and can be configured to communicate with an opening and closing mechanism within the valve 400 and with one or more pressure sensors within the fluid bladder 304. In this example, signals related to the requested firmness can be transmitted from the external device 602 to the opening and closing mechanism within the valve 400 based on pressure values received from the one or more pressure sensors within the fluid bladder 304.

In another method, the subject 600 on the substrate 300 can be identified, for example, based on a profile associated with the subject 600. The profile can be associated with an application running on the external device 602, and an identity-specific firmness associated with the profile can be made available to the monitoring controller for implementation once the subject 600 is identified as present on the substrate 300. In other words, if the subject 600 is identified as present on the substrate 300, for example, based on a pressure profile or on the presence of a specific external device 602, and a profile including an identity-specific firmness is available for that subject 600, the monitoring controller can open the valve 400 to modify the firmness to the identity-specific firmness based on the profile.

The external device 602 can include applications configured to receive pressure signals from the sensors within the fluid bladder 304 and to perform pattern recognition, or other calculations, based on the pressure signals to determine the position, heart rate, respiratory rate, or other bio-signal properties or conditions associated with the subject 600. For example, the heart rate can be identified based on a portion of the signal that has a frequency in the range of 0.5-4.0 Hz and the respiration rate can be identified based on a portion of the signal has a frequency in the range of less than 1 Hz. This information can be made accessible to the subject 600 or another user in the form of text messages, a data log, a print-out, an alert, or any other display means sufficient to allow the user to monitor the information.

FIG. 7 shows an example of system architecture for monitoring a subject, such as the subject 600 shown in FIG. 6, using a non-intrusive monitoring apparatus in accordance with implementations of this disclosure. In some embodiments, the non-intrusive monitoring apparatus may include or be in communication with one or more pressure sensors 700. In some embodiments, the pressure sensors 700 associated with the substrate 300 can include pillow pressure sensors and other pressures sensors to indicate that additional pressure measurements can be made in association with the system for monitoring the position of the subject.

Each sensor in the group of pressure sensors 700 can communicate with a signal conditioner 710. The signal conditioner 710 can analyze the data and/or signals captured by each sensor in the group of pressure sensors 700 by, for example, amplifying, filtering noise, and configuring the data and/or signals for use by a micro controller 720. The micro controller 720 can receive the conditioned pressure signals from the group of pressure sensors 700 and can perform pattern recognition, or other calculations, based on the conditioned pressure signals to determine the position, heart rate, respiratory rate, or other bio-signal properties or conditions associated with the subject. The micro controller 720 can send information, such as information indicating the parameters of the subject, such as the position, heart rate, and respiratory rate, to the external device 602 of FIG. 6 using a communication link 730. The communication link can be any type of wired or wireless communication link such as the communications links 108, 110 described in respect to FIG. 1.

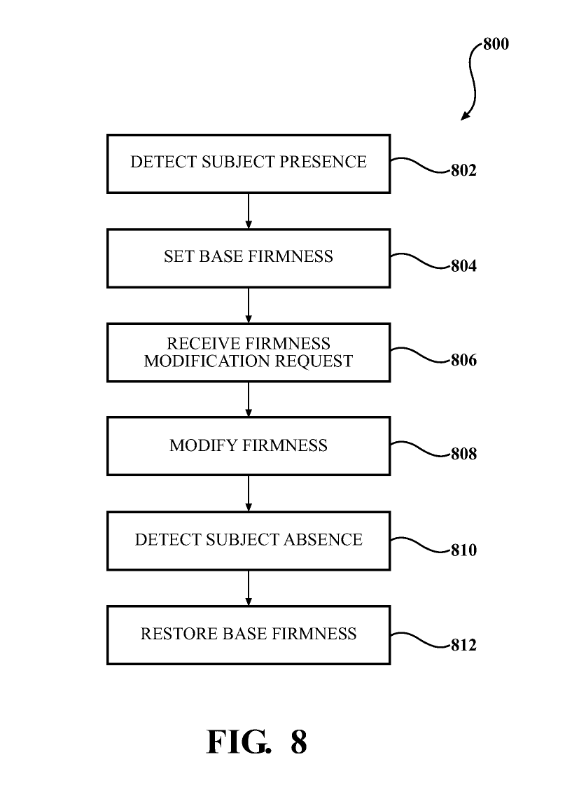

FIG. 8 is a flowchart detailing an example process 800 of automatic firmness control in accordance with implementations of this disclosure. In step 802 of the process 800, the presence of a subject can be detected on a substrate, such as the subject 600 on the substrate 300 as shown in FIG. 6. Detecting the presence of the subject 600 can include a computing device, such as the monitoring controller or the external device 602 described in respect to FIG. 6, receiving an indication indicative of a pressure increase within the fluid bladder 304 of the substrate 300.

For example, one or more sensors, such as the pressure sensor(s) 700 described in FIG. 7, can measure incident pressure waves within the fluid bladder 304. The sensors can then send the generated signals to the monitoring controller and/or external device 602. In some embodiments, the presence determination can be based on the magnitude of the pressure signals. For example, a smaller object, such as a cat or a suitcase, would create pressure signals of lower magnitude than the subject 600 lying on the substrate 300. In some embodiments, the monitoring controller or the external device 602 can determine that a different subject is on the substrate 300. For example, the pressure signals can differ in pattern or magnitude than previously stored pressure signals for the subject 600 associated with the substrate 300.

In step 804 of the process 800, and in response to detection of the presence of the subject, the firmness of the substrate can be set to a base firmness equalized with atmospheric pressure. For example, as described in reference to FIGS. 5-6, setting the firmness of the substrate 300 to the base firmness includes setting the valve 400 to a closed position as soon as presence of the subject 600 is detected. Since the valve 400 was previously open in the absence of the subject 600, the pressure within the fluid bladder 304 was equalized with atmospheric pressure. Closing the valve 400 sets the firmness of the substrate 300 at this base firmness.

In step 806 of the process 800, a request can be received to modify the firmness of the substrate, for example, to a requested firmness or an identity-specific firmness. The request can be received from the external device 602 of FIG. 6 through the subject's 600 use of an application on the external device 602 configured to allow control of the firmness of the substrate 300. Alternatively, the request can be based on the subject 600 being both identified and present on the substrate 300 as determined automatically by the monitoring controller or the external device 602, for example, in association with a profile of the subject 602 where an identity-specific firmness for the substrate 300 is pre-set by the subject 602.

In step 808 of the process 800, and in response to receiving the request to modify the firmness of the substrate, the firmness of the substrate can be modified to, for example, the requested firmness or the identity-specific firmness. For example, as described in reference to FIGS. 5-6, setting the firmness of the substrate 300 to the requested firmness or the identity-specific firmness includes setting the valve 400 to the open position only for a predetermined time period. The predetermined time period is that sufficient to lower the pressure within the fluid bladder 304 and compress the foam core 302 to reduce the firmness of the substrate 300 to the requested firmness or the identity-specific firmness. In the above examples, the requested firmness and the identity-specific firmness are softer than the base firmness, as the substrate 300 is does not include a pump to increase pressure within the fluid bladder 304 above atmospheric pressure. However, in other embodiments, the substrate can include a pump, and the requested firmness or the identity-specific firmness can be firmer than the base firmness.

In step 810 of the process 800, the absence of a subject can be detected on a substrate, as would be the case with the empty substrate 300 shown in FIG. 5. Detecting the absence of the subject 600 can include a computing device, such as the monitoring controller or the external device 602 described in respect to FIG. 6, receiving an indication indicative of a pressure decrease within the fluid bladder 304 of the substrate 300 immediately upon the subject 300 exiting the substrate 300. The pressure decrease can have a magnitude associated with the subject 600 or can exceed a threshold sufficient to indicate that the subject 600 has vacated the substrate 300.

In step 812 of the process 800, and in response to detection of the absence of the subject, the firmness of the substrate can be restored to the base firmness. For example, as described in reference to FIGS. 5-6, restoring the firmness of the substrate 300 to the base firmness includes setting the valve 400 to the open position such that the foam core 302 fully expands within the fluid bladder 304 and equilibrium with atmospheric pressure is attained within the fluid bladder 304. In the embodiment where two valves are employed, one pressure-controlled valve and one single-direction check valve, restoring the firmness of the substrate 300 can occur automatically when the check valve opens in the absence of the subject 600. After step 812, the process 800 can end or repeat by starting again at step 802.

While the embodiments have been described in connection with what is presently considered to be the most practical examples, it is to be understood that the disclosure is not to be limited to these examples but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for automatically controlling firmness of a substrate, comprising:
detecting presence of a subject on the substrate;
in response to detection of the presence of the subject, setting the firmness of the substrate to a base firmness equalized with atmospheric pressure;
in response to receiving a request to modify the firmness of the substrate from the base firmness to a requested firmness, setting the firmness of the substrate to the requested firmness;
detecting absence of the subject on the substrate; and
in response to detection of the absence of the subject, restoring the firmness of the substrate from the requested firmness to the base firmness.

2. The method of claim 1, wherein detecting presence of the subject includes receiving an indication indicative of a pressure increase.

3. The method of claim 1, wherein detecting absence of the subject includes receiving an indication indicative of a pressure decrease.

4. The method of claim 1, wherein the requested firmness is selected by the subject using a remote device.

5. The method of claim 1, wherein the substrate includes:
a fluid bladder;
a foam core disposed within the fluid bladder;
a pressure-controlled valve having an open position allowing fluid communication between atmosphere and an interior of the fluid bladder and the foam core and a closed position blocking fluid communication between atmosphere and the interior of the fluid bladder and the foam core; and
a check valve having an open position allowing fluid communication between atmosphere and the interior of the fluid bladder and the foam core only in the absence of the subject on the substrate.

6. The method of claim 5, wherein setting the firmness of the substrate to the base firmness in response to detection of the presence of the subject includes setting the pressure-controlled valve to the closed position.

7. The method of claim 5, wherein setting the firmness of the substrate to the requested firmness includes setting the pressure-controlled valve to the open position only for a predetermined time period, the predetermined time period being sufficient to lower the pressure within the fluid bladder and reduce the firmness of the substrate to the requested firmness.

8. The method of claim 5, wherein restoring the firmness of the substrate to the base firmness includes the check valve automatically achieving the open position in the absence of the subject on the substrate such that the foam core fully expands within the fluid bladder.

9. A method for automatically controlling firmness of a substrate, comprising:
detecting presence of a subject on the substrate;
in response to detection of the presence of the subject, setting the firmness of the substrate to a base firmness equalized with atmospheric pressure;
detecting identity of the subject on the substrate;
in response to detection of the identity of the subject, setting the firmness of the substrate to an identity-specific firmness;
detecting absence of the subject on the substrate; and
in response to detection of the absence of the subject, restoring the firmness of the substrate from the specified firmness to the base firmness.

10. The method of claim 9, wherein detecting presence of the subject includes receiving an indication indicative of a pressure increase.

11. The method of claim 9, wherein detecting absence of the subject includes receiving an indication indicative of a pressure decrease.

12. The method of claim 9, wherein the identity-specific firmness is based on a profile associated with the subject.

13. The method of claim 9, wherein the substrate includes:
a fluid bladder;
a foam core disposed within the fluid bladder; and
a valve having an open position allowing fluid communication between atmosphere and an interior of the fluid bladder and the foam core and a closed position blocking fluid communication between atmosphere and the interior of the fluid bladder and the foam core.

14. The method of claim 13, wherein setting the firmness of the substrate to the base firmness in response to detection of the presence of the subject includes setting the valve to the closed position.

15. The method of claim 13, wherein setting the firmness of the substrate to the identity-specific firmness includes setting the valve to the open position only for a predetermined time period, the predetermined time period being sufficient to lower the pressure within the fluid bladder and reduce the firmness of the substrate to the identity-specific firmness.

16. The method of claim 13, wherein restoring the firmness of the substrate from the identity-specific firmness to the base firmness includes setting the valve to the open position such that the foam core fully expands within the fluid bladder.

17. A substrate, comprising:
a fluid bladder;
a foam core disposed within the fluid bladder;
one or more sensors in fluid communication with the fluid bladder;
a valve having an open position allowing fluid communication between atmosphere and an interior of the fluid bladder and the foam core and a closed position blocking fluid communication between atmosphere and the interior of the fluid bladder and the foam core; and
a processor configured to:
detect, based on signals from the one or more sensors, presence of a subject on the substrate;
in response to detection of the presence of the subject, set firmness of the substrate to a base firmness equalized with atmospheric pressure;
in response to receiving a request to modify the firmness of the substrate from the base firmness to a requested firmness, set the firmness of the substrate to the requested firmness;
detect absence of the subject on the substrate; and
in response to detection of the absence of the subject, restore the firmness of the substrate from the requested firmness to the base firmness.

18. The substrate of claim 17, wherein setting the firmness of the substrate to the base firmness in response to detection of the presence of the subject includes setting the valve to the closed position.

19. The substrate of claim 17, wherein setting the firmness of the substrate to the requested firmness includes setting the valve to the open position only for a predetermined time period, the predetermined time period being sufficient to lower the pressure within the fluid bladder and reduce the firmness of the substrate to the requested firmness.

20. The substrate of claim 17, wherein restoring the firmness of the substrate from the requested firmness to the base firmness includes setting the valve to the open position such that the foam core fully expands within the fluid bladder.
